(19) United States
(12) Patent Application Publication
(10) Pub. No.: US 2006/0028462 A1
(43) Pub. Date: Feb. 9, 2006

(54) Calibration method

(75) Inventor: Youichi Ono, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Minolta Medical & Graphic, Inc., Tokyo (JP)

(21) Appl. No.: 11/195,277

(22) Filed: Aug. 2, 2005

(30) Foreign Application Priority Data
Aug. 4, 2004 (JP) 2004-228106
Aug. 6, 2004 (JP) 2004-230927

(51) Int. Cl. G09G 5/00

(52) U.S. Cl. 345/204

(57) ABSTRACT

A calibration method includes: displaying an image for calibration at a position of a region of interest of a medical image to be a display object of a display unit of a medical image display apparatus; adjusting the luminance level of the displayed image for calibration by observing by visual observation; and correcting the display gradation characteristic of the medical image display apparatus based on the adjustment result.

### BACKGROUND OF THE INVENTION

1. Field of the Invention

The present invention relates to a calibration method for correcting a display gradation characteristic of a medical image display apparatus based on a visual observation of an operator.

2. Description of the Related Art

In the field of medicine, a monitor diagnosis of performing an interpretation of a radiogram by displaying a medical image of a patient, which has been obtained by various kinds of examination photographing such as X-ray radiographing, a magnetic resonance imaging (MRI) scan, and an ultrasonic wave scan, on a monitor has been being prevalent. Moreover, it is also possible to perform the interpretation of the same image on monitors located at different places with the development of internal and external networks of a hospital. However, in the case where the monitors used for interpretations of radiograms are different kind ones such as a liquid crystal display (LCD) and a cathode ray tube (CRT), because their display characteristics differ from each other, even the same images would be differently seen sometimes. Moreover, even in the case of the same kind of monitors, sometimes the same images would also be seen differently from each other owing to the differences of the degrees of deterioration caused by the use of the monitors, the installed environments of the monitors, and the like.

Thus, when an image is differently seen on each monitor, the accuracy of diagnosis is thereby influenced. Consequently, it is necessary to unify the appearances of the images on the respective monitors by performing the correction of their display gradation characteristics (hereinafter referred to as calibration). Although the calibration is conventionally performed using a luminance meter, because the luminance meter is generally expensive, the calibration using the luminance meter brings about a high cost. Moreover, in the case where there are many monitors for interpretations of radiograms, the operation of performing the calibration of each monitor using the luminance meter one by one takes a lot of trouble, and very troublesome.

On the other hand, a method of confirming a calibration result by a visual observation of an operator after the implementation of the calibration using a luminance meter was proposed (see, for example, JP-Tokukai-Hei 11-327501 referred to as Patent Document 1 below). The calibration method described in the Patent Document 1 is one displaying a plurality of test patterns displayed at luminance levels different from one another on a monitor to let an operator (observer) confirm the luminance level of each test pattern by visual observation.

Moreover, a calibration method of correcting the display gradation characteristic of a display device based on a result of an adjustment made by an operator while visually observing the luminance level of the adjustment region of a test pattern displayed on a screen in a way of being switched one by one among a plurality of test patterns, each including a reference region and an adjustment region, has been proposed.

However, because the adjoining test patterns came into the view of an operator together with a test pattern of a judgment object when calibration was performed by displaying a plurality of test patterns on one screen like the method of the Patent Document 1, the accuracy of the visibility of the operator fell, and it was difficult to perform accurate calibration.

Moreover, also a display device having a large screen has been developed recently, and then a problem concerning that the degrees of the influences of ambient light such as indoor light and sunlight are different depending on the display position of an image, has been caused.

Moreover, in the case where one of a plurality of test patterns, each having a reference region and an adjustment region, is switched one by one to be displayed on a screen while an operator performs calibration by visual observation, the boundary of the reference region and the adjustment region of the test pattern just before the switching of the display of each test pattern influences as an afterimage. Consequently, the accuracy of the visibility of the operator falls, and it is difficult to perform accurate calibration.

### SUMMARY OF THE INVENTION

It is an object of the present invention to make it possible to efficiently correct the display gradation characteristic of a medical image display apparatus displaying a medical image. Moreover, it is another object of the present invention to improve the accuracy of the visibility of an operator to make it possible to perform calibration by visual observation more accurately.

For achieving the above objects, in accordance with a first aspect of the present invention, a calibration method displays an image for calibration at a position of a region of interest of a medical image to be a display object of a display unit of a medical image display apparatus, adjusts a luminance level of the displayed image for calibration by observing by visual observation, and corrects a display gradation characteristic of the medical image display apparatus based on an adjustment result.

According to the first aspect of the present invention, because the image for calibration is displayed at the position of the region of interest of the medical image to be the display object of the display unit, the display gradation characteristic can be corrected according to the position of the region of interest, which is the most important at the time of observing the medical image. Consequently, the correction of the display gradation characteristic of the medical image display apparatus can be performed efficiently.

Preferably, a position of a region of interest of a medical image displayed on the display unit in the past are previously saved at every photographing portion and/or in every photographing direction, and in displaying the image for calibration on the display unit, a position of a region of interest of a medical images having a photographing portion and/or a photographing direction same as that of the medical image to be the display object is obtained among the saved position of the region of interest of the medical image, and the position of the region of interest of the medical image to be the display object is determined based on the obtained position of the region of interest to display the image for calibration at the determined position of the region of interest.

According to this invention, the positions of the regions of interests of the medical images displayed on the display unit in the past are previously saved at every photographing portion and/or at every photographing direction, and in displaying the image for calibration on the display unit, the positions of the regions of interests of the medical images each having the photographing portion and/or the photographing direction same as those of the medical image to be the display object are obtained among the saved positions of the regions of interests of the medical images, and further the position of the region of interest of the medical image to be the display object is determined based on the obtained positions of the regions of interests to display the image for calibration at the determined position of the region of interest. Consequently, the display gradation characteristic can be corrected in accordance with an average position of the positions of the regions of interests of the medical images each having the same photographing portion and/or the same photographing direction as those of the medical image to be the display object.

Preferably, the position of the region of interest of the displayed medical image is appointed on a screen on which the medical image to be the display object is displayed by the display unit, and the image for calibration is displayed at the appointed position of the region of interest.

According to this invention, the position of the region of interest of the displayed medical image is appointed on the screen on which the medical image to be the display object is displayed by the display unit, and the image for calibration is displayed at the appointed position of the region of interest. Consequently, the display gradation characteristic can be corrected according to the position appointed by the operator.

In accordance with a second aspect of the present invention, a calibration method displays an image for calibration at each of a plurality of positions on a display screen of a display unit of a medical image display apparatus, and adjusts a luminance level of the displayed image for calibration by observing by visual observation, and further obtains correction data for correcting a display gradation characteristic of the medical image display apparatus based on an adjustment result, and still further corrects the display gradation characteristic of the medical image display apparatus based on the correction data obtained in a neighborhood of a position of a region of interest of a medical image to be a display object when the medical image to be the display object is displayed on the display unit.

According to the second aspect of the present invention, because the aspect displays the image for calibration at each of the plurality of positions on the display screen of the display unit of the medical image display apparatus, and adjusts the luminance level of the displayed image for calibration by observing by visual observation, and further obtains the correction data for correcting the display gradation characteristic of the medical image display apparatus based on the adjustment result, and still further corrects the display gradation characteristic of the medical image display apparatus based on the correction data obtained in the neighborhood of the position of the region of interest of the medical image to be the display object when the medical image to be the display object is displayed on the display unit, the display gradation characteristic can be corrected according to the position of the region of interest, which is the most important at the time of observing the medical image. Consequently, the display gradation characteristic of the medical image display apparatus can be efficiently corrected.

In accordance with a third aspect of the present invention, a calibration method makes a display unit of a medical image display apparatus display one of a plurality of test patterns, each including a reference region and an adjustment region, on a screen in a way of being switched one by one, and makes the display unit display a plain pattern having a single luminance level in a transition process from a display of a test pattern to a display of another test pattern, and further adjusts a luminance level of the adjustment region of the displayed test pattern by observing by visual observation, and still further corrects a display gradation characteristic of the medical image display apparatus based on an adjustment result.

According to the third aspect of the present invention, because the plain pattern having the single luminance level is displayed in the transition process from the display of a test pattern to the display of another test pattern, it can be prevented that the accuracy of the visibility of an operator falls because the boundary between the reference region and the adjustment region remains as an afterimage. Consequently, the accuracy of the visibility of the operator can be improved, and calibration can be performed more accurately.

Preferably, the single luminance level of the plain pattern is a luminance level same as that of a reference region of a test pattern displayed after the plain pattern.

According to this invention, the single luminance level of the plain pattern is made to be the same luminance level of the reference region of the test pattern displayed after the plain pattern, and consequently the eyes of an operator are adapted to the luminance level of the test pattern to be visually recognized to improve the accuracy of the visibility. Thus, calibration can be accurately performed.

Preferably, a display of the plain pattern is performed for a predetermined constant time or until detecting an instruction from an operator.

According to this invention, because the plain pattern is displayed for the predetermined constant time or until detecting the instruction from the operator, it can be prevented that the accuracy of the visibility of the operator falls owing to an afterimage. Consequently, calibration can be performed more accurately.

A part of the displaying of the plain pattern may be omitted.

According to the invention, by omitting a part of the displays of the plain pattern, a time necessary for calibration can be shortened.

### BRIEF DESCRIPTION OF THE DRAWINGS

The present invention will be fully understood from the following detailed description taken in conjunction with the accompanying drawings, but those should not be interpreted to limit the present invention to them, in which:

FIG. 1 is a block diagram showing the internal configuration of a medical image display apparatus 10 according to a first embodiment;

FIG. 2 is a view showing test patterns [n] displayed at the time of display gradation characteristic adjustment processing;

FIG. 3 is a view illustrating two display regions constituting a test pattern [n];

FIG. 4 is a view showing test patterns [n] composed of line pairs;

FIG. 5 is a view illustrating a line pair image constituting a test pattern [n];

FIG. 6 is a flowchart illustrating calibration processing 1 executed by the medical image display apparatus 10;

FIG. 7 is a flowchart illustrating the display gradation characteristic adjustment processing;

FIG. 8 is a graph showing a function g(DDL);

FIG. 9 is a graph showing a function h(DDL);

FIG. 10 is a graph showing a correction curve for correcting a display gradation characteristic of the medical image display apparatus 10;

FIG. 11 is a flowchart illustrating calibration processing 2 executed by a medical image display apparatus according to a second embodiment;

FIG. 12 is a flowchart illustrating calibration processing 3 executed by a medical image display apparatus according to a third embodiment;

FIG. 13 is a view showing a display example of a medical image display screen 131;

FIG. 14 is a display example of a display gradation characteristic adjustment screen 132;

FIG. 15 is a view showing each of positions 1-6 on a display gradation characteristic adjustment screen 133, where the display gradation characteristic adjustment processing is performed;

FIG. 16 is an example of LUT information obtained by the display gradation characteristic adjustment processing;

FIG. 17 is a flowchart illustrating gradation conversion processing of a display image which processing is executed by a medical image display apparatus according to a fourth embodiment;

FIG. 18 is a view showing a display example of a medical image display screen 134;

FIG. 19 is a view for illustrating a creation method of an LUT at an ROI position enclosed by four points at each of which an LUT has been obtained beforehand;

FIG. 20 is a flowchart illustrating calibration processing 4 executed by a medical image display apparatus according to a fifth embodiment;

FIG. 21 is a view for illustrating a display order of test patterns [n] and plain patterns in the fifth embodiment;

FIG. 22 is a flowchart illustrating calibration processing 5 executed by a medical image display apparatus according to a sixth embodiment;

FIG. 23 is a view for illustrating a display order of test patterns [n] and plain patterns;

FIG. 24 is a flowchart for illustrating calibration processing 6 executed by a medical image display apparatus according to a seventh embodiment; and

FIG. 25 is a view for illustrating a display order of test patterns [n] and plain patterns according to the seventh embodiment.

### DETAILED DESCRIPTION OF THE PREFERRED EMBODIMENTS

### First Embodiment

In a first embodiment, an example of displaying an image for calibration (hereinafter referred to as a test pattern) at a position of a region of interest (hereinafter referred to as an ROI) of a medical image at the time of calibration is described.

First the configuration thereof is described.

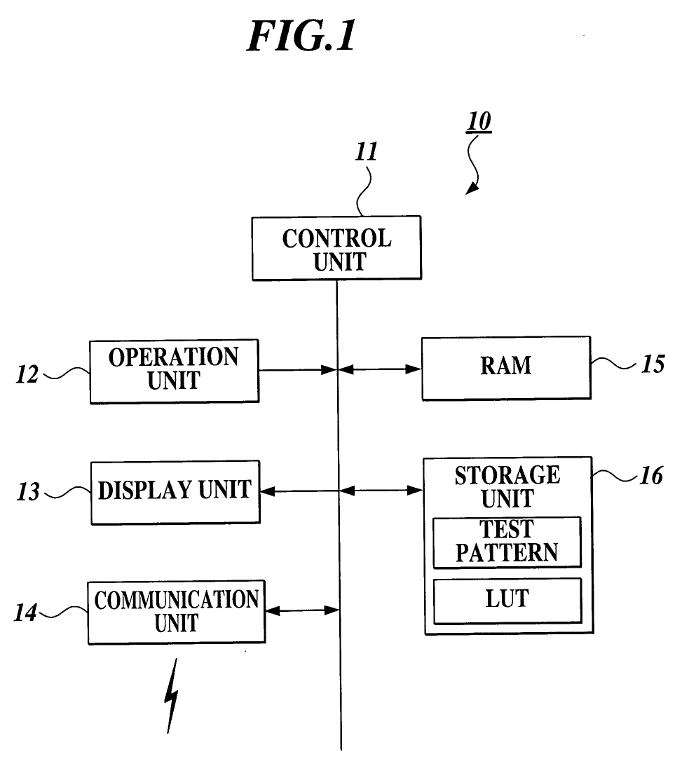

The internal configuration of a medical image display apparatus 10 in the first embodiment is shown in FIG. 1.

As shown in FIG. 1, the medical image display apparatus 10 is composed of a control unit 11, an operation unit 12, a display unit 13, a communication unit 14, a random access memory (RAM) 15 and a storage unit 16.

The control unit 11 unwinds various control programs, which are stored in the storage unit 16, such as a system program and a calibration processing program according to the present invention, to the RAM 15, and performs the centralized control of the operation of each unit in conformity with the control program.

To put it concretely, the control unit 11 outputs N pieces of data of test patterns set at respective drive levels at which the medical image display apparatus 10 can perform display drives, and makes the display unit 13 display the outputted data. When the control unit 11 makes the display unit 13 display the N test patterns, the control unit 11 generates screen data of placing one test pattern on one screen, and outputs the generated screen data to the display unit 13. Thereby, the control unit 11 displays one pattern on one screen in the way of switching the patterns one by one.

Then, when an adjustment operation of the luminance level of the displayed test pattern has been performed through the operation unit 12, the control unit 11 alters the drive level of the test pattern in accordance with the operation instruction to drive the display unit 13 to display the altered test pattern. When the adjustment operation has ended, the control unit 11 obtains a correction curve for correcting the display gradation characteristic of the medical image display apparatus 10 based on the value of the drive level of each test pattern after the adjustment. Then, the control unit 11 creates a look up table (LUT) in which output values (drive levels) to input values of the correction curve are prescribed, and makes the storage unit 16 store the created LUT therein.

Incidentally, the display characteristic means a correlation between drive levels and luminance levels, and the display gradation characteristic means a correlation between input levels of pixel values in image data of a display object and the luminance levels at the time of displaying the image data.

The operation unit 12 includes a keyboard and a mouse. When the keyboard or the mouse is operated, the operation unit 12 generates an operation signal according to the operation, and outputs the generated operation signal to the control unit 11. Incidentally, the operation unit 12 may include a touch panel or the like which is integrally formed with the display unit 13.

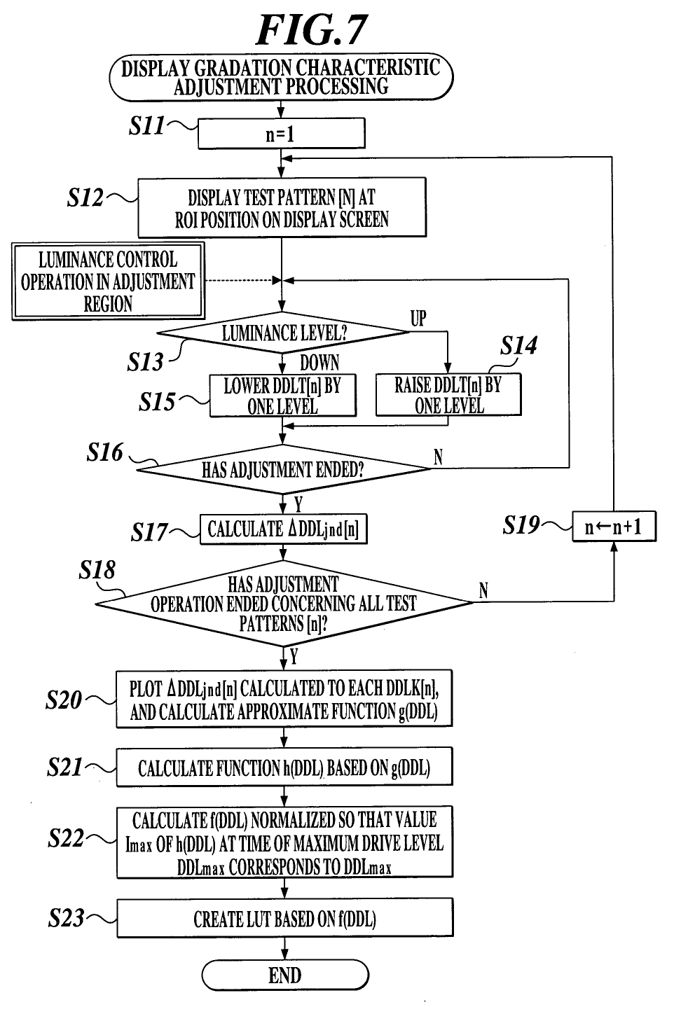

The display unit 13 has a monitor such as an LCD and a CRT, and drives the monitor in conformity with a display control signal inputted from the control unit 11. The display unit 13 displays one of the test patterns inputted from the control unit 11 on one screen in the way of switching the test pattern one by one at the time of display gradation characteristic adjustment processing, which will be described later (see FIG. 7).

The communication unit 14 includes communication interfaces such as a network interface card (NIC), a modem, and a router, and performs data communication with external apparatuses on a local area network (LAN) provided in a hospital through the communication interfaces. For example, the communication unit 14 accesses an image server managing medical images of patients made to be a database to obtain the data of a medical image.

The RAM 15 forms a work area which temporarily stores various programs to be executed by the control unit 11, the data processed by these programs, and the like.

The storage unit 16 is composed of a magnetic or an optical recording medium, a semiconductor memory, or the like, and stores various control programs such as a system program and the calibration processing program. Moreover, the storage unit 16 stores a LUT for correcting the display gradation characteristic of the medical image display apparatus 10, which LUT has been created by, for example, the display gradation characteristic adjustment processing as a processing result of a program. Moreover, the storage unit 16 stores medical images obtained through the communication unit 14 from external apparatuses. Photographing portion information and photographing direction information are annexed to the medical images as annexed information. Incidentally, the annexed information may be inputted from the operation unit 12.

Moreover, the storage unit 16 stores the data of a plurality of test patterns used in the display gradation characteristic adjustment processing.

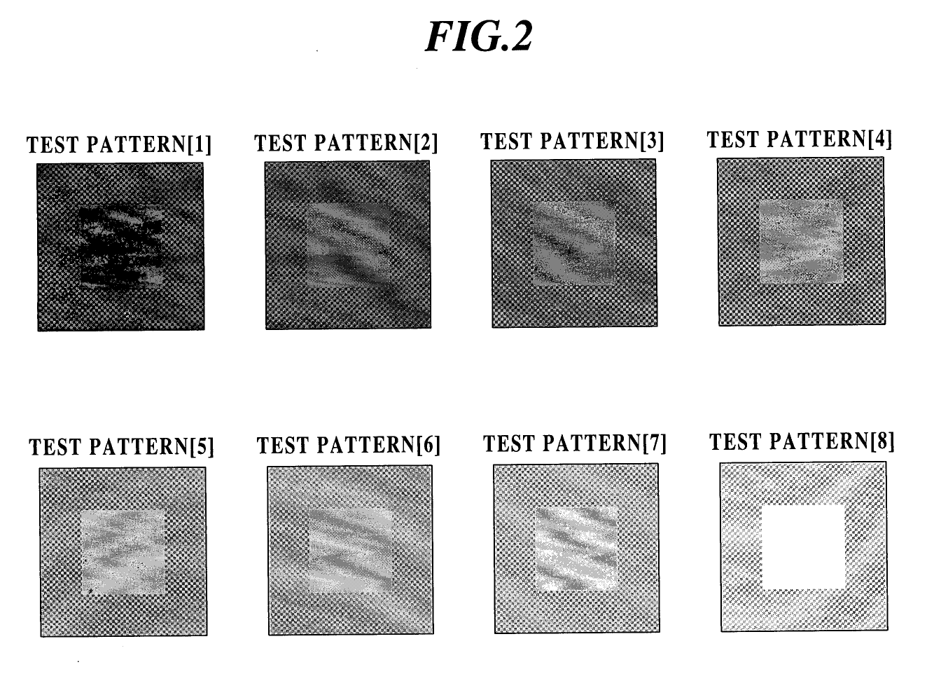

Examples of test patterns are shown in FIG. 2.

As shown in FIG. 2, the test patterns [n] (n in the brackets denotes a pattern number given for identifying each test pattern. n=1, 2, . . . , N) are ones created according to respective drive levels which are respective divided parts of the division of the level range of the drive levels capable of being driven by the display unit 13, namely a range of from 0 to the maximum drive level DDLₘₐₓ, into (N−1) equal parts. Incidentally, although an example of division into seven equal parts is shown in the present embodiment, the number of the equal division is made to be suitably set according to the accuracy of calibration. In the case where the calibration is performed at high accuracy, it is preferable to increase the number of N.

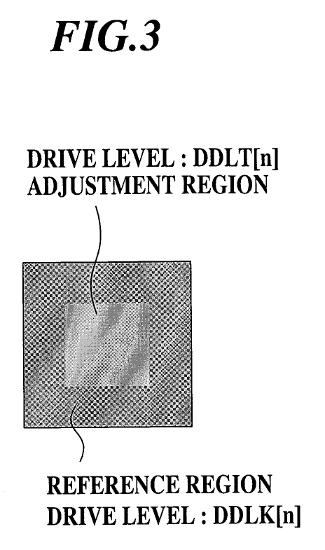

In each test pattern [n], two display regions in which different drive levels are set are formed as shown in FIG. 3. One of the drive levels of the division of the maximum drive level DDLₘₐₓ into (N−1) equal parts is set in one display region, and a drive level higher than the drive level set in the one display region by a predetermined level is set in the other display region. That is, the drive level of the adjustment region is set in order that the drive level is higher in luminance than that of the reference region.

When the drive level of the reference region of the test pattern [n] is denoted by DDLK [n] and the drive level of the adjustment region of the test pattern [n] is denoted by DDLT [n], the drive level DDLK [n] is expressed by the following formula 1, and the drive level DDLT [n] is expressed by the following formula 2.

$$DDLK [ n ] = \frac{n - 1}{N - 1} \times {DDL}_{max} \qquad ( 1 )$$

DDLT[n]=DDLK[n]+ΔDDLᵢₙᵢₜ (2)
where ΔDDLᵢₙᵢₜ denotes a constant.

Incidentally, only for the test pattern [N], the formulae are modified as follows.
DDLK[N]=DDLₘₐₓ−ΔDDLᵢₙᵢₜ (3)
DDLT[N]=DDLₘₐₓ (4)

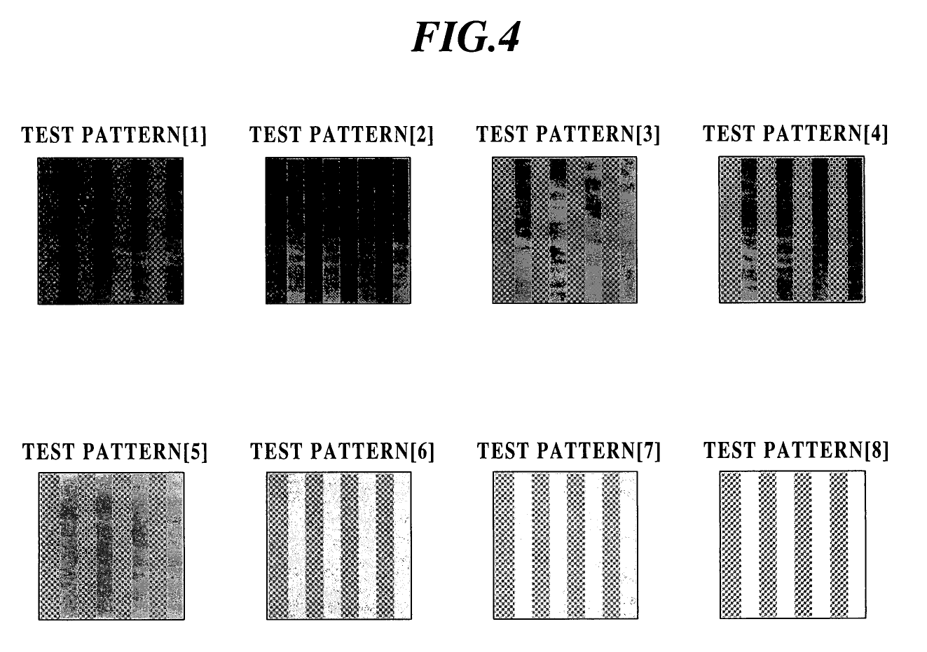

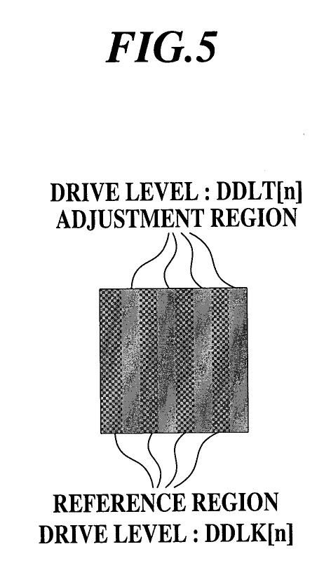

Incidentally, the test patterns [n] are not limited to those formed of the display regions shaped in squares as shown in FIGS. 2 and 3, but the test patterns [n] formed of the display regions shaped in lines as shown in FIGS. 4 and 5 may be adopted.

In each test pattern [n] shown in FIG. 4, a plurality of line pairs are formed in which each line pair is composed of two line-like display regions to which different drive levels from each other are set as shown in FIG. 5. One line of each of the line pairs is set as a reference region, and the other line of each of the line pairs is set as an adjustment region. Also in this case, the drive levels of the adjustment regions and the reference regions in each test pattern [n] may be set similarly in the examples shown in FIGS. 2 and 3. That is, the adjustment regions are set to have higher luminance levels than those of the reference regions.

Next, the calibration processing executed by the medical image display apparatus 10 using the test patterns [n] is described.

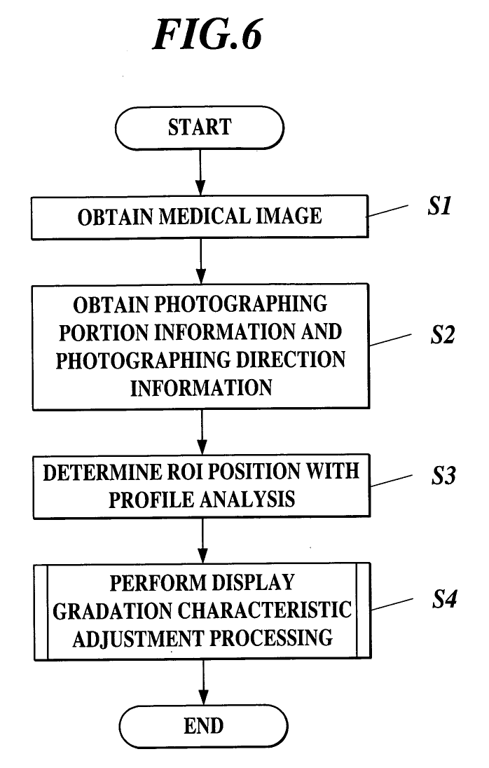

FIG. 6 is a flowchart illustrating calibration processing 1.

First, a medical image stored in an external apparatus such as an image server is obtained through the communication unit 14 (Step S1). The obtained medical image is stored in the storage unit 16.

Then, the photographing portion information and the photographing direction information both are annexed to the medical image are obtained (Step S2).

Then, the medical image receives a profile analysis based on the obtained photographing portion information and the obtained photographing direction information, and the ROI position which is an object of a diagnosis of the medical image is determined (Step S3).

Next, in the display unit 13, each test pattern [n] is displayed at the ROI position of the medical image being the display object, and the display gradation characteristic adjustment processing of the medical image display apparatus 10 is performed (Step S4).

With reference to FIG. 7, the display gradation characteristic adjustment processing of the medical image display apparatus 10 is minutely described. As shown in FIG. 7, the pattern number n of a test pattern [n] to be displayed is first set to n=1, which is an initial value (Step S11). When the pattern number n has been set, in the control unit 11, the data of the test pattern [n] having the pattern number n is read from the storage unit 16. Then, display screen data by which the test pattern [n] is placed at the ROI position on the display screen is generated. The generated display screen data is outputted to the display unit 13. In the display unit 13, the display drive of the monitor is performed based on the drive level set to every test pattern, and the display screen including the test pattern [n] is displayed (Step S12).

Because the degree of the influence of ambient light such as indoor light and sunlight differs according to a display position in case of observing a medical image, the luminance levels which the operator visually recognizes may differ depending on positions although the luminance levels have been displayed as the same luminance level. Accordingly, by placing the test pattern [n] at a position corresponding to the ROI position, which is the most important position when the medical image is observed, to let the operator perform adjustment, the calibration in consideration of the environmental conditions at the time of observing the medical image can be performed. For example, when interpretation of radiogram of a medical image in which a breast is photographed is performed, the concern is especially concentrated to the region of a mammary gland portion. By adjusting the display gradation characteristic according to the ROI position, effective calibration can be performed.

When a test pattern [n] is displayed in such a way, the operator performs an adjustment operation of raising or lowering the luminance level of the adjustment region through the operation unit 12 until the luminance level difference between the adjustment region and the reference region of the test pattern [n] becomes a luminance level difference which is the minimum level difference capable of being visually recognized by visual observation. The minimum luminance level difference capable of being visually recognized indicates a luminance level difference at a limit of being capable of visually recognizing the luminance level difference as a result of operator's adjusting the luminance level of the adjustment region according to the luminance level of the reference region. To put it concretely, the luminance level is adjusted until a stage at which the operator would be unable to identify the luminance level difference between the adjustment region and the reference region if the luminance level of the adjustment region were lowered by more one level.

In the medical image display apparatus 10, when an operation of luminance adjustment of an adjustment region is made through the operation unit 12, the signal analysis of the operation signal is performed, and it is discriminated which the operation instruction is directed to raising the luminous level or to lowering the luminous level (Step S13). When the operation instruction is directed to raising the luminance level (Step S13; up), the drive level DDLT [ n] of the adjustment region is increased by one level, and the adjustment region which is displayed is driven to be displayed at the increased drive level DDLT [n] (Step S14). On the other hand, when the operation instruction is directed to lowering the luminance (Step S13; down), the drive level DDLT [n] of the adjustment region is lowered by one level, and the adjustment region which is displayed is driven to be displayed at the lowered drive level DDLT [n] (Step S15). That is, one drive level is raised or lowered in response to one operation, and a display is performed at the raised or lowered luminance level. Incidentally, even when the operation of lowering the luminance level of the adjustment region is repeated, the adjustment operation is made to be limited by invalidating the adjustment operation of making the luminance level equal to the drive level of the reference region or less, or by a similar measure lest the luminance level of the adjustment region should be equal to the luminance level of the reference region or less.

When the adjustment operation of the drive level has been performed, it is discriminated whether the adjustment operation has ended or not (Step S16). When the adjustment operation is still being performed through the operation unit 12 (Step S16; N), the processing returns to the process of Step S13, and the luminance level is adjusted in conformity with the inputted operation instruction. On the other hand, when the adjustment operation has ended (step S16; Y), a drive level DDLT′ [n] of the adjustment region of the test pattern [n] at the time of the adjustment end is judged, and a difference ΔDDL_{jnd} [n] between the drive level DDLT′ [n] and the drive level DDLK [n] of the reference region is calculated (Step S17). The difference ΔDDL_{jnd} [n] corresponds to the minimum luminance level difference in the test pattern [n] which the operator can visually recognize.

Subsequently, it is discriminated whether the adjustment operation mentioned above has ended about all of the test patterns [n] or not (Step S18). When the adjustment operation has not ended about all of the test patterns [n] (step S18; N), the pattern number n is incremented by only one (Step S19), and the processing returns to the process of Step S12. That is, the display screen of the next test pattern [n] is displayed, and the adjustment operation is repeated.

As described above, by sequentially incrementing the pattern number n and by repeating the processes from Steps S12 to S17, in the display unit 13, each test pattern [n] is sequentially displayed in the order of the pattern number.

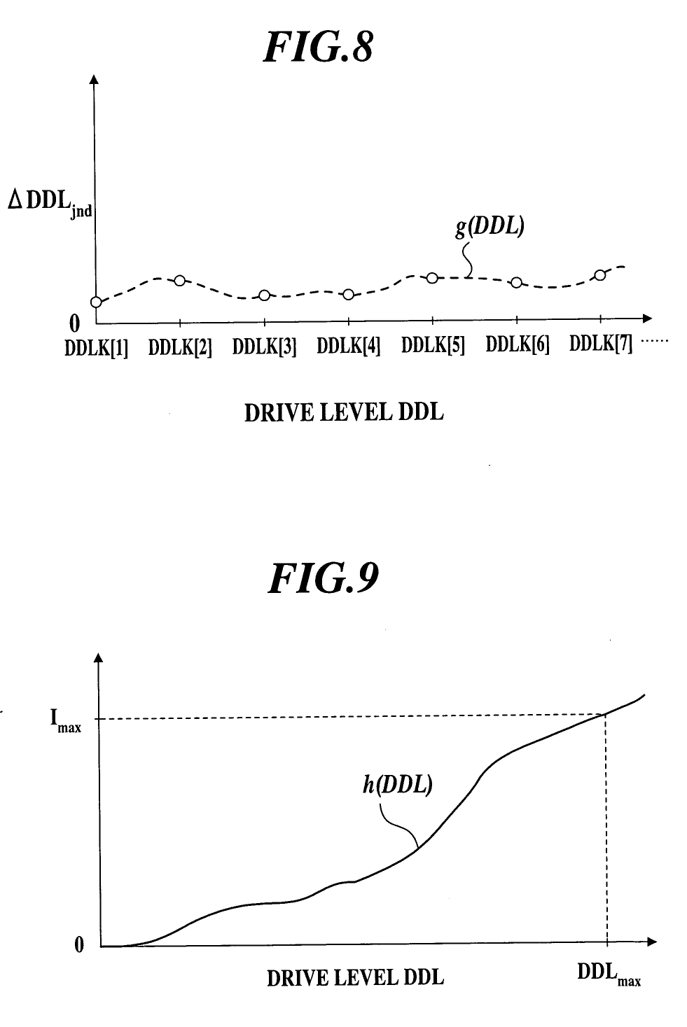

Then, when all the test patterns [n] have been displayed and the adjustment operation has ended (step S18; Y), as shown in FIG. 8, the difference ΔDDL_{jnd} [n] calculated to the drive level DDLK [n] of the reference region of each test pattern [n] is plotted, and an approximate function g(DDL) of each plotted point is calculated (Step S20). That is, each difference ΔDDL_{jnd} [n], which is a discrete value, is interpolated, and a continuous value corresponding to the drive level DDL of all level ranges is obtained. The approximate function g(DDL) is a function showing a correspondence relation between the drive level DDL and the minimum drive level difference ΔDDL_{jnd} [n].

Subsequently, a function h(DDL) obtained by integrating the calculated function g(DDL) by the drive level DDL is calculated by the following formula 5 (Step S21). The above function g(DDL) indicates the inclination of the function h(DDL).

$$h ( DDL ) = {\int }_{0}^{DDL} g ( DDL ) ⅆ DDL \qquad ( 5 )$$

FIG. 9 is a graph showing the function h(DDL). The abscissa axis thereof indicates the drive level DDL, and the ordinate axis thereof indicates the function h(DDL) to the drive level DDL. In this case, supposing that a value of the function h(DDL) corresponding to the maximum drive level DDLₘₐₓ which can be driven by the medical image display apparatus 10 is set to Iₘₐₓ, the function h(DDL) (i.e. the values of the ordinate axis) is normalized so that the value Iₘₐₓ corresponds to the maximum drive level DDLₘₐₓ, and a function f(DDL) indicating the normalized function h(DDL) is calculated by the following formula 6 (Step S22).

$$f ( DDL ) = \frac{h ( DDL )}{{I}_{max}} \times {DDL}_{max} \qquad ( 6 )$$

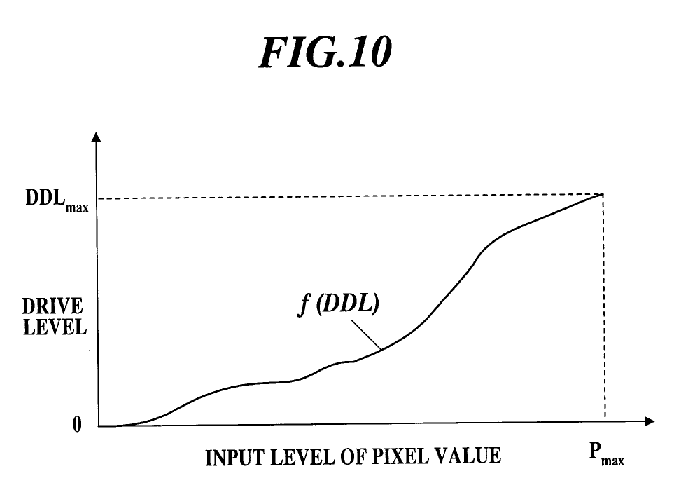

Then, a curve shown in FIG. 10 is created. The curve is obtained by substituting the drive levels DDL, which are the units of the abscissa axis of FIG. 9, with the input levels of pixel values, and by substituting the function h(DDL), which is the unit of the ordinate axis, with the calculated function f(DDL). Hereupon, Pₘₐₓ in FIG. 10 indicates the maximum gradation which can be expressed by the medical image display apparatus 10. With this curve, a drive level realizing a corresponding luminance level from the input level of a pixel value can be obtained in order that the input level of the pixel value may be finally displayed at a luminance level visually linear to the input level of the pixel value. That is, the curve f(DDL) is a correction curve for correcting the display gradation characteristic (a relation between the input level of a pixel value and a luminance level at the time of being actually displayed according to the input level) according to the display characteristic of the medical image display apparatus 10. In the control unit 11, the output values to the input values of this correction curve are calculated and are tabled to create a LUT (Step S23). Then, the created LUT is stored in the storage unit 16 as a LUT for correcting the display gradation characteristic of the medical image display apparatus 10.

When a medical image is displayed, the created LUT is referred to, and the drive level (output value) corresponding to the input level (input value) of a pixel value of the medical image is obtained to perform a display drive at the drive level. Because the drive level obtained from the LUT is a drive level corrected in order that the luminance level at the time of being driven to be displayed by the drive level may be in a visually linear relation with the input level of the pixel value, consequently the display gradation characteristic of the medical image display apparatus 10 is corrected according to the display characteristic of the medical image display apparatus 10 and the visual characteristic of the operator.

This is the end of the calibration processing 1.

As described above, according to the first embodiment, because a test pattern [n] is displayed at an ROI position of a medical image, being a display object of the display unit 13, a display gradation characteristic can be corrected according to the ROI position, which is the most important at the time of observing the medical image. Consequently, the correction of the display gradation characteristic of the medical image display apparatus 10 can be performed efficiently.

Moreover, when the display gradation characteristic adjustment processing at and after the second time is performed, the drive level DDLT′ [n] of the adjustment region at the end of the adjustment obtained by the display gradation characteristic adjustment processing at the last time may be used as the initial value of the drive level of the adjustment region. Consequently, the man-hour at the adjustment process can be reduced in comparison with the case where a drive level higher than the drive level DDLK [n] of the reference region by a constant ΔDDLᵢₙₜ is used as the initial value of the drive level of the adjustment region.

### Second Embodiment

Next, a second embodiment to which the present invention is applied is described.

Because a medical image display apparatus according to the second embodiment has the similar configuration as that of the medical image display apparatus 10 shown as the first embodiment, the same components are denoted by the same reference marks as those of the first embodiment, and the descriptions of the same components are omitted. Moreover, the test patterns shown in FIG. 2 are also used as the test patterns used for calibration similarly to the first embodiment. Hereinafter, the processes peculiar to the second embodiment are described.

In the second embodiment, a method of performing calibration based on stored past data after performing the same calibration processing 1 as that of the first embodiment by a plurality of times is described. In the storage unit 16, the ROI positions of the medical images displayed on the display unit 13 in the past are stored by every photographing portion and by every photographing direction.

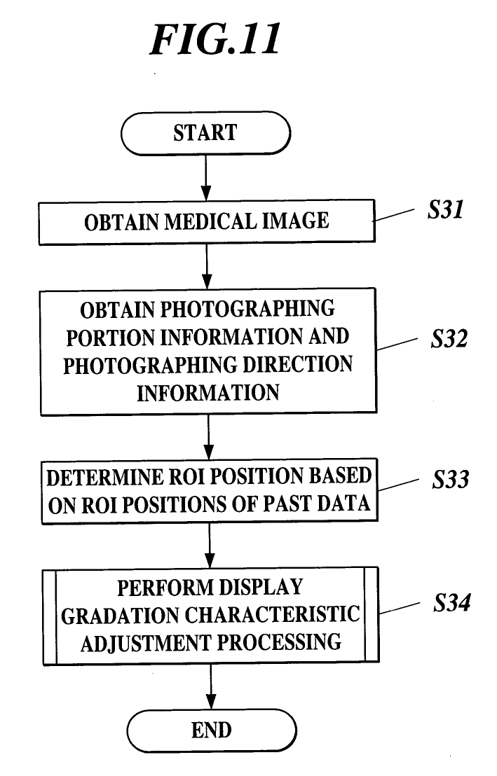

FIG. 11 is a flowchart illustrating calibration processing 2 executed by the medical image display apparatus of the second embodiment.

First, a medical image stored in an external apparatus such as an image server is obtained through the communication unit 14 (Step S31). The obtained medical image is stored in the storage unit 16.

Next, the photographing portion information and the photographing direction information both annexed to the medical image are obtained from the medical image (Step S32).

Then, the ROI positions of the medical images having the same photographing portions and the same photographing directions as those of the medical image to be a display object are obtained among the ROI positions of the medical images stored in the storage unit 16 based on the obtained photographing portion information and the obtained photographing direction information. An average position of the obtained ROI positions is calculated based on the obtained ROI positions, and the ROI position of the medical image to be the display object is determined (Step S33).

Next, each of the test patterns [n] is displayed at the ROI position of the medical image to be the display object, and the display gradation characteristic adjustment processing of the medical image display apparatus is performed (Step S34). Because the details of the display gradation characteristic adjustment processing are similar to those of the first embodiment, the descriptions of the details are omitted.

This is the end of the calibration processing 2.

As described above, according to the second embodiment, the ROI positions of the medical images displayed on the display unit 13 in the past are stored by every photographing portion and by every photographing direction. When the test pattern [n] is displayed on the display unit 13, the ROI positions of the medical images having the same photographing portions and the same photographing directions as those of the medical image to be a display object are obtained among the ROI positions of the stored medical images, and the ROI position of the medical image to be the display object is determined based on the obtained ROI positions. Then, the test pattern [n] is displayed at the determined ROI position. Consequently, the display gradation characteristic can be corrected according to an average position of the ROI positions of the medical images having the same photographing portions and the same photographing directions as those of the medical image to be the display object.

Incidentally, although the ROI positions of the medical images displayed on the display unit 13 in the past are made to be stored by every photographing portion and by every photographing direction in the second embodiment, the classification method of the medical images is not limited to the method. The test pattern [n] may be displayed at an average position of the group to which the medical image to be the display object belongs according to the classification method of the medical images.

### Third Embodiment

Next, a third embodiment to which the present invention is applied is described.

Because a medical image display apparatus according to the third embodiment has the similar configuration as that of the medical image display apparatus 10 shown as the first embodiment, the same components are denoted by the same reference marks as those of the first embodiment, and the descriptions of the same components are omitted. Moreover, the test patterns shown in FIG. 2 are also used as the test patterns used for calibration similarly to the first embodiment. Hereinafter, the processes peculiar to the third embodiment are described.

In the third embodiment, calibration is performed at a position appointed by an operator on a display screen on which a medical image is displayed.

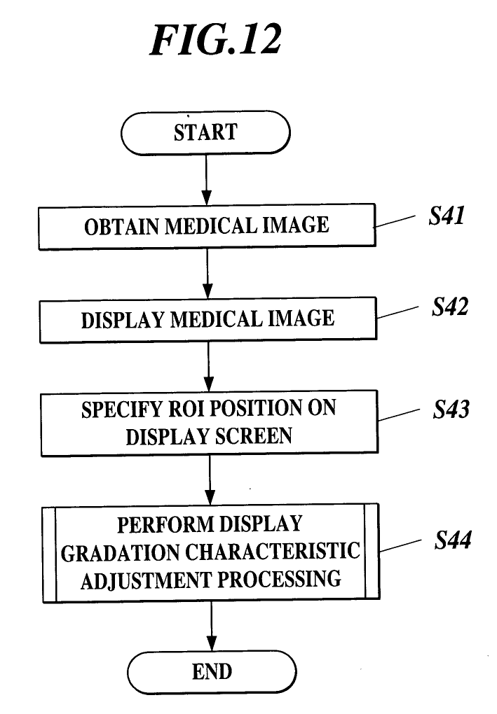

FIG. 12 is a flowchart illustrating calibration processing 3 executed by the medical image display apparatus of the third embodiment.

First, a medical image stored in an external apparatus such as an image server is obtained through the communication unit 14 (Step S41). The obtained medical image is stored in the storage unit 16.

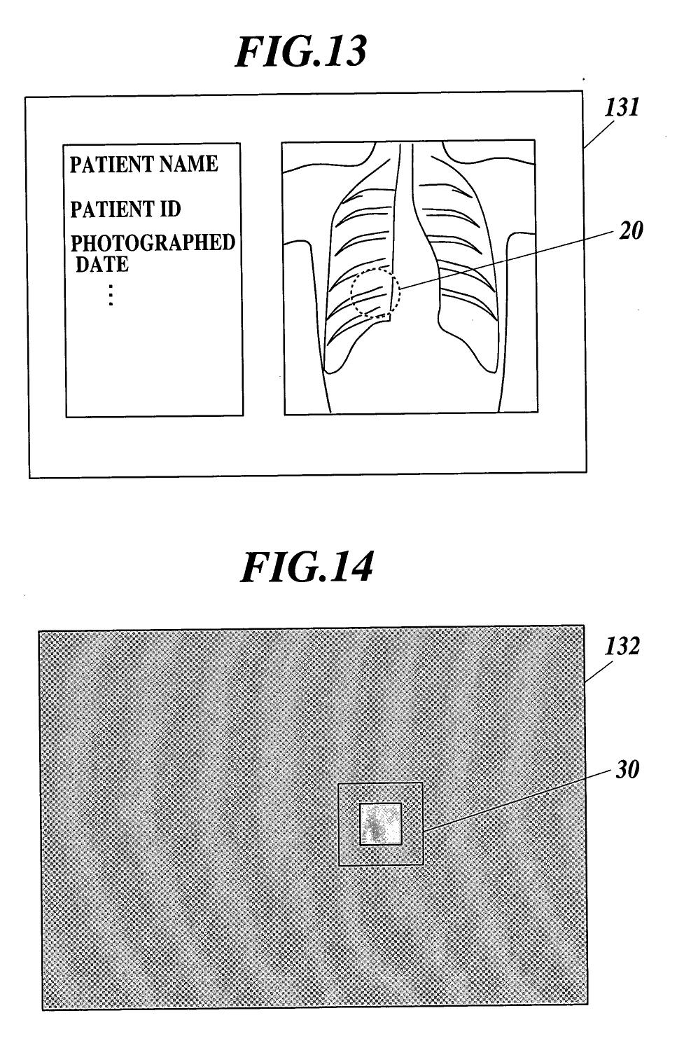

Next, the medical image is displayed on the display unit 13 (Step S42). An example of a medical image display screen 131 is shown in FIG. 13. A patient name, a patient ID, a photographed date and the like may be displayed on the medical image display screen 131 in addition to the medical image.

An operator performs an operation on the medical image display screen 131 displayed on the display unit 13 with the operation unit 12 to appoint an ROI position 20 (see FIG. 13) of the displayed medical image (Step S43). For example, by a mouse operation of the operation unit 12, the operator performs a right click of the mouse at the ROI position 20 of the medical image, and selects “calibration” in the displayed selection window.

When the ROI position 20 is appointed by the operator, as shown in FIG. 14, a display gradation characteristic adjustment screen 132 is displayed on the display unit 13. In the display gradation characteristic adjustment screen 132, each test pattern 30 is displayed at the appointed ROI position 20, and the display gradation characteristic processing of the medical image display apparatus is performed (Step S44). Because the details of the display gradation characteristic adjustment processing are similar to those of the first embodiment, the descriptions of the details are omitted.

This is the end of the calibration processing 3.

As described above, according to the third embodiment, on a screen on which the display unit 13 is made to display a medical image to be a display object, an ROI position of the displayed medical image is appointed, and the test patterns [n] are displayed at the appointed ROI position. Consequently, the display gradation characteristic can be corrected according to the position appointed by the operator.

### Fourth Embodiment

Next, a fourth embodiment to which the present invention is applied is described.

Because the medical image display apparatus according to the fourth embodiment has the similar configuration as that of the medical image display apparatus 10 shown as the first embodiment, the same components are denoted by the same reference marks as those of the first embodiment, and the descriptions of the same components are omitted. Moreover, the test patterns shown in FIG. 2 are also used as the test patterns used for the calibration similarly to the first embodiment. Hereinafter, the processes peculiar to the fourth embodiment are described.

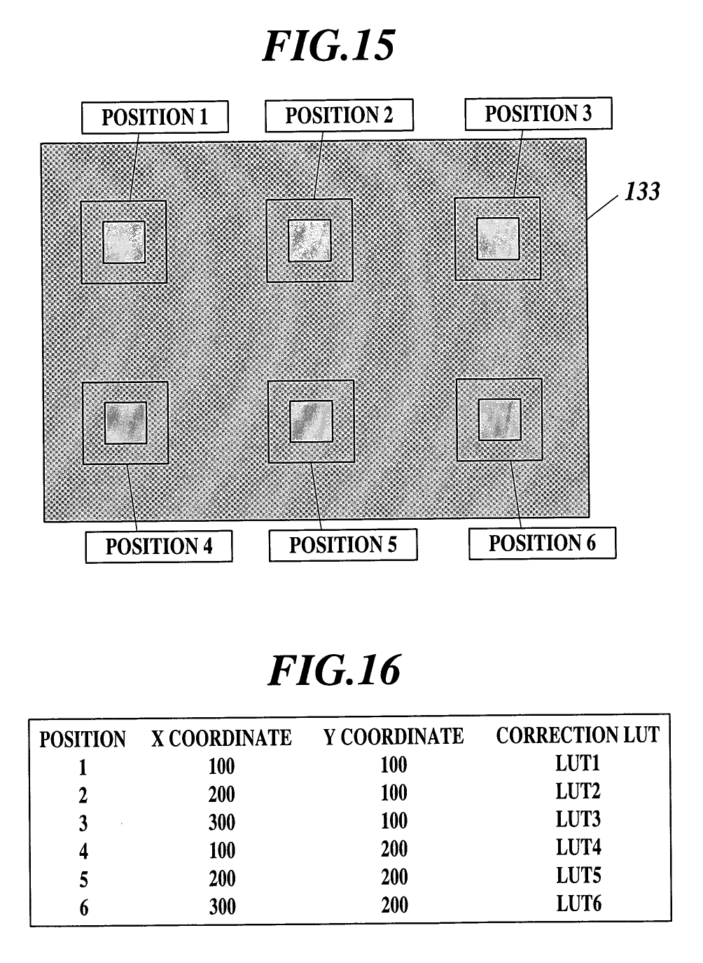

First, as shown in FIG. 15, display gradation characteristic adjustment processing is performed at each of positions 1-6 on a display gradation characteristic adjustment screen 133 displayed on the display unit 13. Because the details of the display gradation characteristic adjustment processing are similar to those of the first embodiment, the descriptions of the details are omitted. However, although the test patterns [n] are made to be displayed at the ROI position on the display screen in the display gradation characteristic adjustment processing shown in FIG. 7 (see Step S12), hereupon the test patterns [n] are displayed at respective positions 1-6. The results of the display gradation characteristic adjustment processing are stored in the storage unit 16. An example of the LUT information obtained by the display gradation characteristic adjustment processing is shown in FIG. 16. As shown in FIG. 16, the storage unit 16 stores X coordinates, Y coordinates, both indicating the respective positions 1-6, and LUT's 1-6 created at the positions.

In the fourth embodiment, the gradation conversion processing of an image to be displayed on the display unit 13 is performed based on the correction data (LUT) obtained at a plurality of positions on display screen on the display unit 13 as described above.

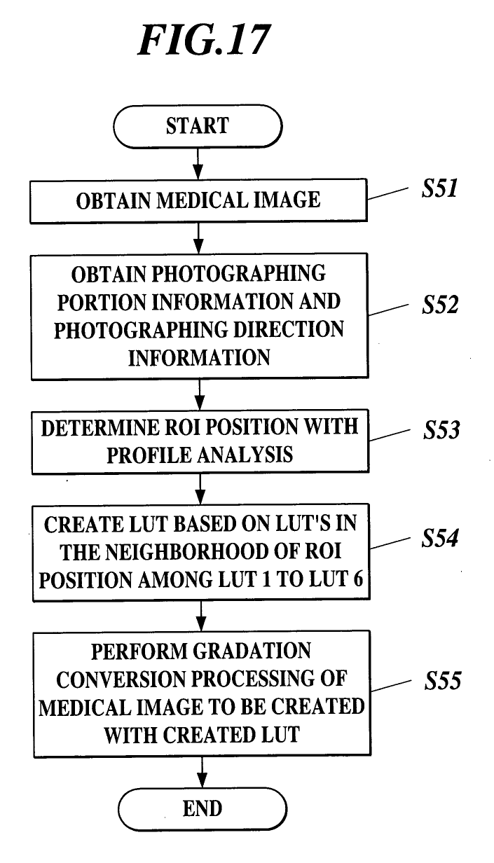

FIG. 17 is a flowchart illustrating the gradation conversion processing of a display image which is executed by the medical image display apparatus according to the fourth embodiment.

First, a medical image stored in an external apparatus such as an image server is obtained through the communication unit 14 (Step S51). The obtained medical image is stored in the storage unit 16.

Next, the photographing portion information and the photographing direction information both annexed to the medical image are obtained from the medical image (Step S52).

Then, the medical image receives the profile analysis based on the obtained photographing portion information and the obtained photographing direction information, and the ROI position is determined (Step S53).

Next, the LUT's obtained in the neighborhood of the ROI position are read from the storage unit 16, and the LUT at the ROI position is created based on the read LUT's (Step S54). The gradation conversion processing of the medical image to be displayed on the display unit 13 is performed using the created LUT (Step S55). Hereupon, the LUT's obtained in the neighborhood of the ROI position mean the LUT's obtained at positions near the ROI position among the LUT's 1-6 obtained at each of the positions 1-6 where the display gradation characteristic adjustment processing has been performed in advance.

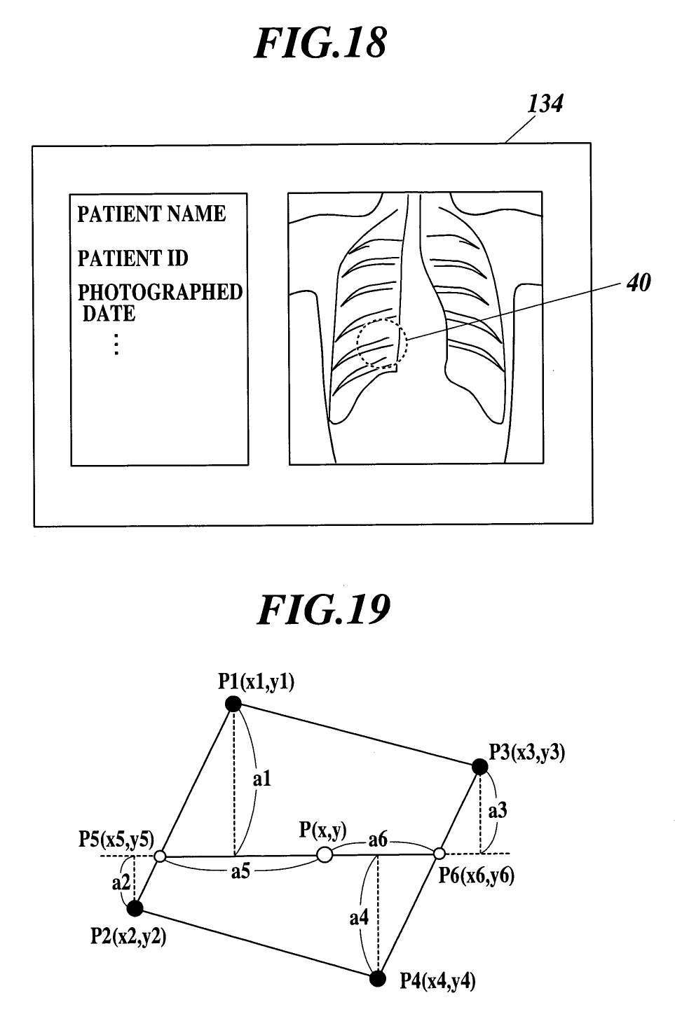

FIG. 18 shows an example of a medical image display screen 134. When a medical image is placed at the position shown in FIG. 18 on the medical image display screen 134, a new LUT is created based on the LUT's 2, 3, 5 and 6 obtained by the display gradation characteristic adjustment processing in the neighborhood of an ROI position 40, namely at the positions 2, 3, 5 and 6 shown in FIG. 15, respectively, and the gradation conversion processing of the medical image to be displayed is performed.

With reference to FIG. 19, a creation method of an LUT at a position enclosed by four points where LUT's have been obtained beforehand is described. The points in the neighborhood of the center point P(x, y) of the ROI are supposed to be P1(x1, y1), P2(x2, y2), P3(x3, y3) and P4(x4, y4), and the LUT's created by the display gradation characteristic adjustment processing at each of the points P1, P2, P3 and P4 are supposed to be LUP_P1[i], LUT_P2[i], LUT_P3[i] and LUT_P4[i], respectively. Hereupon, i is within a range of 0-255 in case of 8 bits.

As shown in FIG. 19, it is supposed that the lengths of perpendicular lines drawn from the respective points P1, P2, P3 and P4 to a straight line which is parallel to the x-axis and passes the central point P of the ROI are a1, a2, a3 and a4, respectively (see formulae 7-10).
a1=|y−y1| (7)
a2=|y−y2| (8)
a3=|y−y3| (9)
a4=|y−y4| (10)

Moreover, it is supposed that intersecting points of the straight line which passes the central point P of the ROI and is parallel to the x-axis with a quadrilateral composed of the points P1, P2, P3 and P4 are P5(x5, y5) and P6(x6, y6) (see formulae 11 and 12), and that the distances from the points P5 and P6 to the central point P of the ROI are a5 and a6, respectively (see formulae 13 and 14).

$$\begin{matrix}x 5 = \frac{a 1 \times x 2 + a 2 \times x 1}{a 1 + a 2} & ( 11 ) \\ x 6 = \frac{a 3 \times x 4 + a 4 \times x 3}{a 3 + a 4} & ( 12 )\end{matrix}$$

a5=|x−x5| (13)
a6=|x−x6| (14)

When the LUT's at the points P5 and P6 are supposed to LUT_P5[i] and LUT_P6[i], respectively, the LUT_P5[i] and the LUT_P6[i] can be obtained from the following formulae 15 and 16, respectively.

$$\begin{matrix}LUT\_P5 [ i ] = \frac{a 1 \times LUT\_P2 [ i ] + a 2 \times LUT\_P1 [ i ]}{a 1 + a 2} & ( 15 ) \\ LUT\_P6 [ i ] = \frac{a 3 \times LUT\_P4 [ i ] + a 4 \times LUT\_P3 [ i ]}{a 3 + a 4} & ( 16 )\end{matrix}$$

Similarly, the LUT_P[i] at the point P can be obtained by the following formula 17.

$$LUT\_P [ i ] = \frac{a 5 \times LUT\_P6 [ i ] + a 6 \times LUT\_P5 [ i ]}{a 5 + a 6} \qquad ( 17 )$$

This is the end of the gradation conversion processing of the display image. The medical image obtained at Step S51 is displayed on the display unit 13 using the created LUT.

As described above, according to the fourth embodiment, the correction data correcting the display gradation characteristic of the medical image display apparatus has been obtained beforehand by performing display gradation characteristic adjustment processing severally at a plurality of positions on the display screen of the display unit 13, and the display gradation characteristic of the medical image display apparatus is corrected based on the correction data obtained in the neighborhood of the ROI position of the medical image to be a display object at the time of making the display unit 13 display the medical image to be the display object. Consequently, the display gradation characteristic can be corrected according to the ROI position, which is the most important at the time of observing the medical image. Thus, the display gradation characteristic of the medical image display apparatus can be efficiently corrected.

Incidentally, in the fourth embodiment, although the LUT suitable to an ROI position is made to be created based on a plurality of LUT's created at a plurality of positions in the neighborhood of the ROI position of a medical image, the LUT created at the nearest position to the ROI position may be applied.

### Fifth Embodiment

Next, a fifth embodiment to which the present invention is applied is described.

Because the medical image display apparatus according to the fifth embodiment has the similar configuration as that of the medical image display apparatus 10 shown as the first embodiment, the same components are denoted by the same reference marks as those of the first embodiment, and the description of the configuration of the fifth embodiment is omitted. Moreover, the test patterns shown in FIG. 2 are also used as the test patterns used for the calibration similarly to the first embodiment. Hereinafter, the configurations and processes which are peculiar to the fifth embodiments are described.

The control unit 11 further makes a display of a plain pattern of a single drive level (i.e. a single luminance level) in a transition process from a display of a test pattern to a display of another test pattern.

Next, the calibration processing executed by the medical image display apparatus according to the fifth embodiment is described.

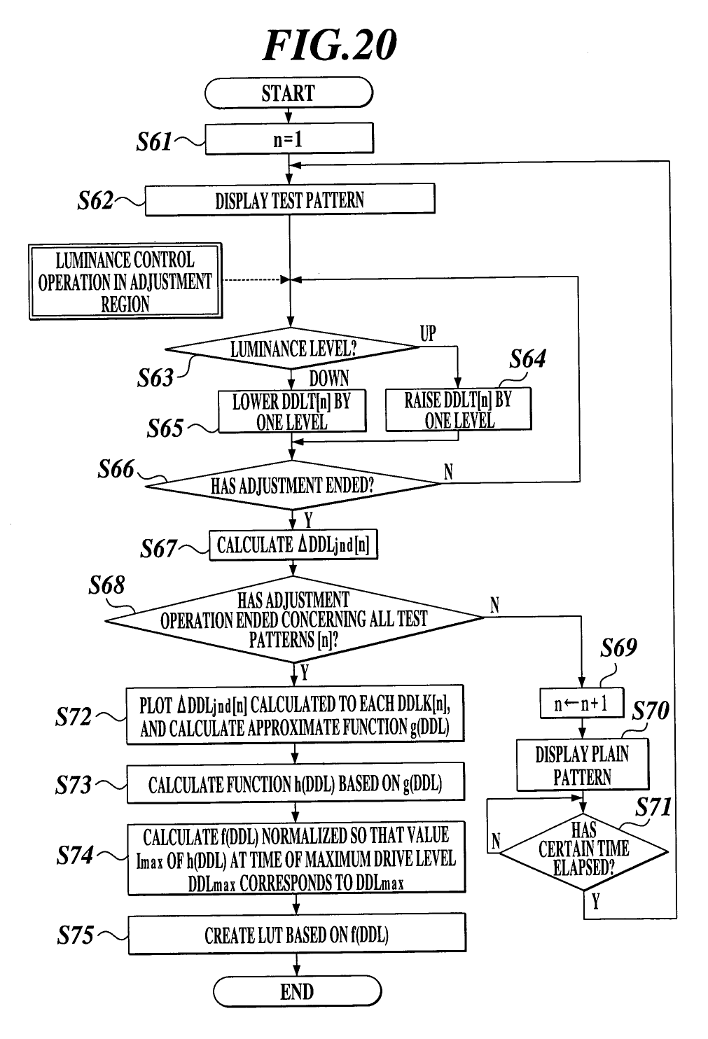

FIG. 20 is a flowchart illustrating calibration processing 4.

First, the pattern number n of a test pattern [n] to be displayed is set to n=1, which is an initial value (Step S61). When the pattern number n has been set, in the control unit 11, the data of the test pattern [n] having the pattern number n is read from the storage unit 16. Then, display screen data including the test pattern [n] is generated. The generated display screen data is outputted to the display unit 13. In the display unit 13, the display drive of the monitor is performed based on the drive level set by every test pattern, and the test pattern [n] is displayed (Step S62).

When a test pattern [n] is displayed, the operator performs an adjustment operation of raising or lowering the luminance level of the adjustment region through the operation unit 12 until the luminance level difference between the adjustment region and the reference region of the test pattern [n] becomes the minimum luminance level difference which can be visually recognized by the visual observation.

In the medical image display apparatus, when an operation of luminance adjustment of an adjustment region is performed through the operation unit 12, the signal analysis of the operation signal is performed, and it is discriminated which the operation instruction is directed to raising the luminous level or to lowering the luminous level (Step S63). When the operation instruction is directed to raising the luminance level (Step S63; up), the drive level DDLT [n] of the adjustment region is increased by one level, and the adjustment region which is displayed is driven to be displayed at the increased drive level DDLT [n] (Step S64). On the other hand, when the operation instruction is directed to lowering the luminance (Step S63; down), the drive level DDLT [n] of the adjustment region is lowered by one level, and the adjustment region which is displayed is driven to be displayed at the lowered drive level DDLT [n] (Step S65). That is, one drive level is raised or lowered in response to one operation, and a display is performed at the raised or lowered luminance level. Incidentally, even when the operation of lowering the luminance level of the adjustment region is repeated, the adjustment operation is made to be limited by invalidating the adjustment operation of making the luminance level equal to the drive level of the reference region or less, or by a similar measure lest the luminance level of the adjustment region should be equal to the luminance level of the reference region or less.

When the adjustment operation of the drive level has been performed, it is discriminated whether the adjustment operation has ended or not (Step S66). When the adjustment operation is still being performed through the operation unit 12 (Step S66; N), the processing returns to the process of Step S63, and the luminance level is adjusted in conformity with the inputted operation instruction. On the other hand, when the adjustment operation has ended (step S66; Y), a drive level DDLT′ [n] of the adjustment region of the test pattern [n] at the time of the adjustment end is discriminated, and a difference ΔDDL_{jnd} [ n] between the drive level DDLT′ [n] and the drive level DDLK [n] of the reference region is calculated (Step S67). The difference ΔDDL_{jnd} [n] corresponds to the minimum luminance level difference in the test pattern [n] which the operator can visually recognize.

Subsequently, it is discriminated whether the adjustment operation mentioned above has ended about all of the test patterns [n] or not (Step S68). When the adjustment operation has not ended about all of the test patterns [n] (step S68; N), the pattern number n is incremented by one (Step S69). Then, in the display unit 13 the display drive of the monitor is performed based on the drive level DDLM for a plain pattern to display the plain pattern (Step S70). Hereupon, the drive level DDLM for the plain pattern is a previously determined constant value, and it is made to be possible to set an arbitrary value. When a predetermined constant time has elapsed in the state in which the plain pattern is displayed on the display unit 13 (Step S71; Y), the processing returns to the process at Step S62. That is, the display screen of the next test pattern [n] is displayed, and the adjustment operation is repeated. Incidentally, a sufficient time for the afterimage of the just preceding test pattern [n] to disappear has been previously set as a constant time during which the plain pattern is displayed.

As described above, by sequentially incrementing the pattern number n and by repeating the processes from Steps S62 to S71, on the display unit 13, plain patterns are displayed in transition processes each from the display of one test pattern to the display of another test pattern while each test pattern [n] is sequentially displayed in the order of the pattern number.

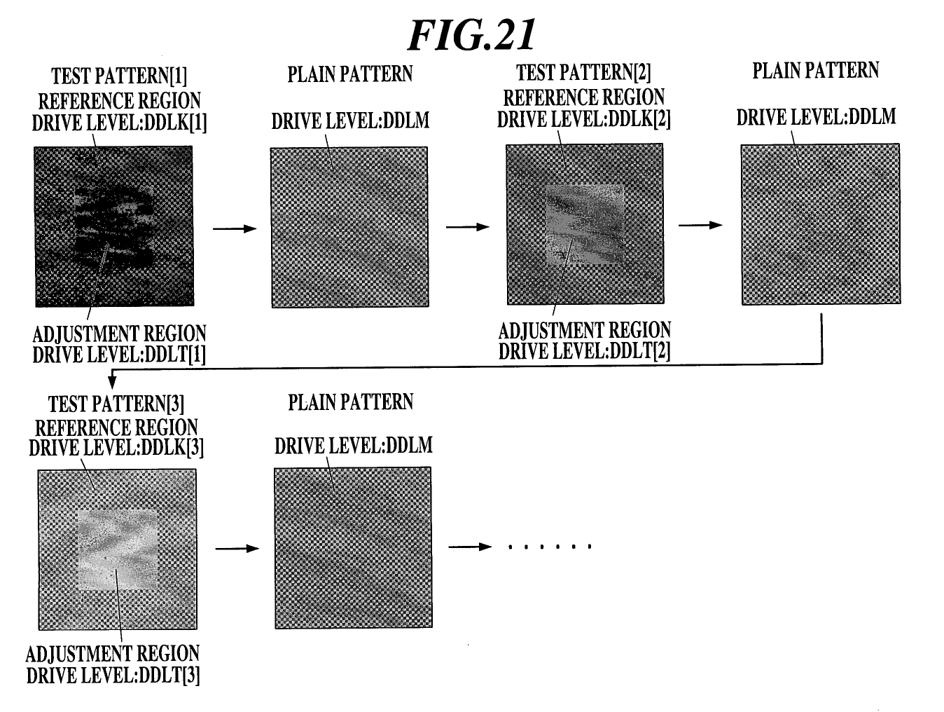

With reference to FIG. 21, the display order of the test patterns [n] and the plain patterns is described. As shown in FIG. 21, first, a test pattern [1] is displayed. When the adjustment operation to the test pattern [1] has ended, a plain pattern (drive level DDLM) is displayed. After the display of the plain pattern for a constant time, a test pattern [2] is displayed. When the adjustment operation to the test pattern [2] has ended, the plain pattern is again displayed. After the display of the plain pattern for the constant time, a test pattern [3] is displayed. After that, similarly the test patterns [n] and the plain patterns are displayed.

Returning to FIG. 20, when all the test patterns [n] have been displayed and the adjustment operation has ended (step S68; Y), as shown in FIG. 8, the difference ΔDDL_{jnd}[n] calculated to the drive level DDLK [n] of the reference region of each test pattern [n] is plotted, and an approximate function g(DDL) of each plotted point is calculated (Step S72).

Subsequently, a function h(DDL) obtained by integrating the calculated function g(DDL) by the drive level DDL is calculated by the formula 5 (Step S73).

Next, in FIG. 9, supposing that a value of the function h(DDL) corresponding to the maximum drive level DDLₘₐₓ which can be driven by the medical image display apparatus is set to Iₘₐₓ, the function h(DDL) (i.e. the values of the ordinate axis) is normalized so that the value Iₘₐₓ corresponds to the maximum drive level DDLₘₐₓ, and a function f(DDL) indicating the normalized function h(DDL) is calculated by the formula 6 (Step S74).

Then, a correction curve shown in FIG. 10 is created. The curve is obtained by substituting the drive levels DDL on the abscissa axis of FIG. 9 with the input levels of pixel values, and by substituting the function h(DDL) on the ordinate axis with the calculated function f(DDL). In the control unit 11, the output values to the input values of this correction curve are calculated and are tabled to create a LUT (Step S75). Then, the created LUT is stored in the storage unit 16 as a LUT for correcting the display gradation characteristic of the medical image display apparatus.

When a medical image is displayed, the created LUT is referred to, and the drive level (output value) corresponding to the input level (input value) of a pixel value of the medical image is obtained to perform a display drive at the drive level. Because the drive level obtained from the LUT is a drive level corrected in order that the luminance level at the time of being driven to be displayed by the drive level may be in a visually linear relation with the input level of the pixel value, consequently the display gradation characteristic of the medical image display apparatus is corrected according to the display characteristic of the medical image display apparatus and the visual characteristic of the operator.

This is the end of the calibration processing 4.

As described above, according to the fifth embodiment, because a plain pattern having a single luminance level is displayed in a transition process from a display of a test pattern to a display of another test pattern, it can be prevented that the accuracy of the visibility of an operator falls owing to an afterimage of a boundary between a reference region and an adjustment region. Consequently, the accuracy of the visibility of the operator can be improved to make it possible to perform the calibration more accurately.

### Sixth Embodiment

Next, a sixth embodiment to which the present invention is applied is described.

Because the medical image display apparatus according to the sixth embodiment has the similar configuration as that of the medical image display apparatus 10 shown as the first embodiment, the same components are denoted by the same reference marks as those of the first embodiment, and the description of the configuration of the sixth embodiment is omitted. Moreover, the test patterns shown in FIG. 2 are also used as the test patterns used for the calibration similarly to the first embodiment. Hereinafter, the processes peculiar to the sixth embodiment are described.

Although the drive levels at the time of displaying the plain patterns are made to be a constant value in the fifth embodiment, in the sixth embodiment, the drive level at the time of displaying a plain pattern is made to be the same drive level as that of the reference region of the test pattern displayed after the plain pattern. That is, the plain patterns are severally displayed at the same luminance levels as those of the reference regions of the test patterns to be displayed after the plain patterns.

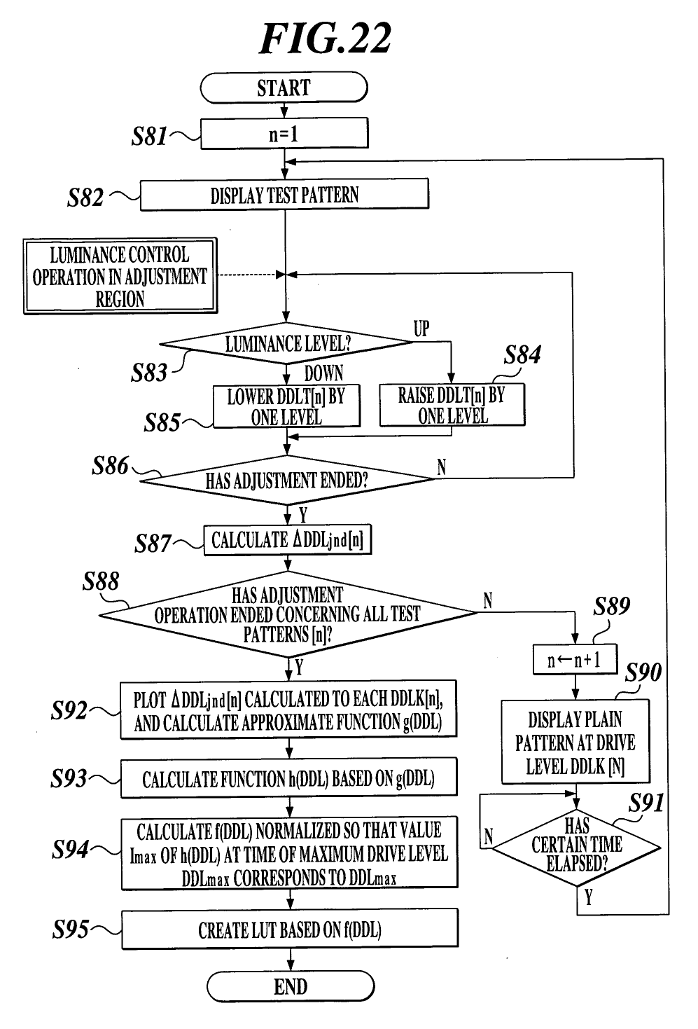

FIG. 22 is a flowchart illustrating calibration processing 5 executed by the medical image display apparatus according to the sixth embodiment.

In FIG. 22, because the processes at Steps S81-S89 are the same as those at Steps S61-S69 of the calibration processing 4 shown in FIG. 20, the descriptions of the processes at Steps S81-S89 are omitted.

At Step S89, after the pattern number n has been incremented by one (Step S89), in the display unit 13, a display drive of the monitor is performed based on the drive level DDLK [n] of the reference region, and a plain pattern is displayed (Step S90). When a predetermined constant time has elapsed in the state in which the plain pattern is displayed on the display unit 13 (Step S91; Y), the processing returns to the process at Step S82. That is, the display screen of the next test pattern [n] is displayed, and the adjustment operation is repeated.

By sequentially incrementing the pattern number n in such a way while repeating the processes at Steps S82-S91, on the display unit 13, the plain patterns are displayed in the transition processes from the display of one test pattern to the display of another test pattern while each test pattern [n] is sequentially displayed in the order of the pattern numbers.

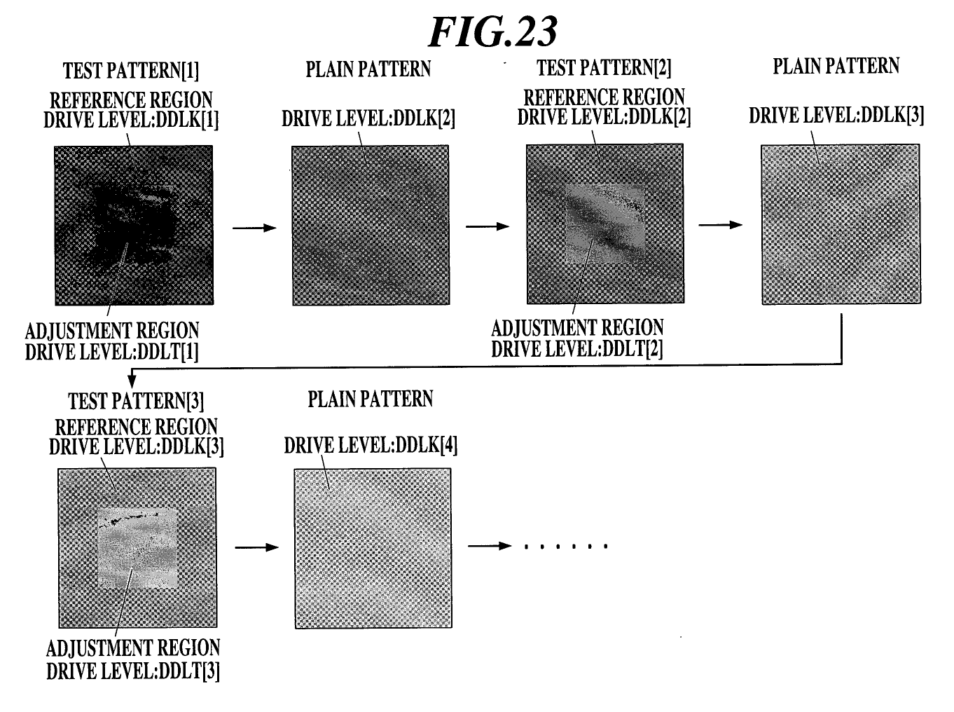

With reference to FIG. 23, the display order of the test patterns [n] and the plain patterns are described. As shown in FIG. 23, when a test pattern [1] has been displayed first and the adjustment operation to the test pattern [1] has ended, a plain pattern is displayed by the drive level same as the drive level DDLK [2] of the reference region of a test pattern [2]. After the plain pattern has been displayed for a constant time, the test pattern [2] is displayed. When the adjustment operation of the test pattern [2] has ended, a plain pattern is displayed by a drive level same as the drive level DDLK [3] of the reference region of a test pattern [3]. After the plain pattern has been displayed for a constant time, the test pattern [3] is displayed. After that, similarly the test patterns [n] and the plain patterns are displayed.

Returning to FIG. 22, when all of the test patterns [n] have been displayed and the adjustment operations have ended (Step S88; Y), the processing moves to the process at Step S92. In FIG. 22, because the processes at Steps S92-S95 are the same as the processes at Steps S72-S75 of the calibration processing 4 shown in FIG. 20, the descriptions of the processes of Steps S92-S95 are omitted.

This is the end of the calibration processing 5.

As described above, according to the sixth embodiment, by setting the single luminance levels of the plain patterns to be the same luminance levels of the reference regions of the test patterns severally displayed after the plain patterns, the eyes of an operator are adapted to the luminance levels of the test patterns to be visually recognized, and the accuracy of the visibility is improved. Consequently, the calibration can be performed more accurately.

### Seventh Embodiment

Next, a seventh embodiment to which the present invention is applied is described.

Because the medical image display apparatus according to the seventh embodiment has the similar configuration as that of the medical image display apparatus 10 shown as the first embodiment, the same components are denoted by the same reference marks as those of the first embodiment, and the description of the configuration of the seventh embodiment is omitted. Moreover, the test patterns shown in FIG. 2 are also used as the test patterns used for the calibration similarly to the first embodiment. Hereinafter, the processes peculiar to the seventh embodiment are described.

Although the next test pattern [n] is displayed after a plain pattern has been displayed for a constant time in the fifth and the sixth embodiment, the next test pattern [n] is displayed after detecting an instruction from an operator in the seventh embodiment.

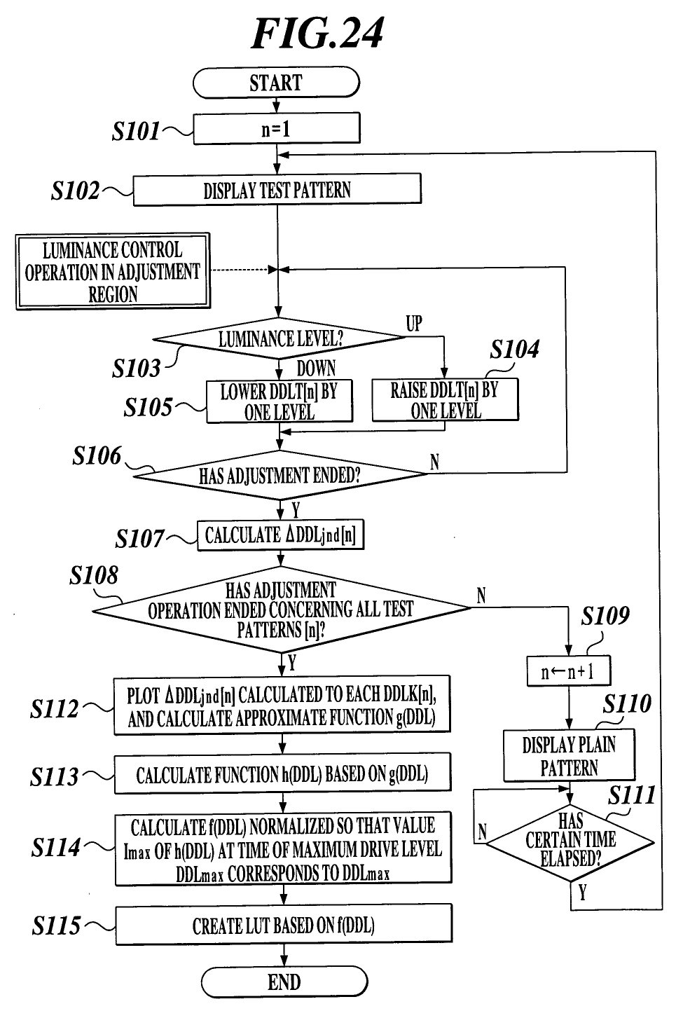

FIG. 24 is a flowchart illustrating calibration processing 6 executed by the medical image display apparatus according to the seventh embodiment.

In FIG. 24, because the processes at Steps S101-S109 are the same as those at Steps S61-S69 of the calibration processing 4 shown in FIG. 20, the descriptions of the processes of Steps S101-S109 are omitted.

At Step S109, after the pattern number n has been incremented by one (Step S109), in the display unit 13, a display drive of the monitor is performed based on the drive level DDLK [n] of the reference region, and a plain pattern is displayed (Step S110). Whether an instruction to display the next test pattern [n] is issued from an operator or not is judged in the state in which the plain pattern is displayed on the display unit 13 (Step S111). When the instruction to display the next test pattern [n] is detected (Step S111; Y), the processing returns to the process at Step S102. That is, the display screen of the next test pattern [n] is displayed, and the adjustment operation is repeated.

By sequentially incrementing the pattern number n in such a way while repeating the processes at Steps S102-S111, the plain patterns are displayed in the transition processes from the display of one test pattern to the display of another test pattern while each test pattern [n] is sequentially displayed in the order of the pattern numbers.

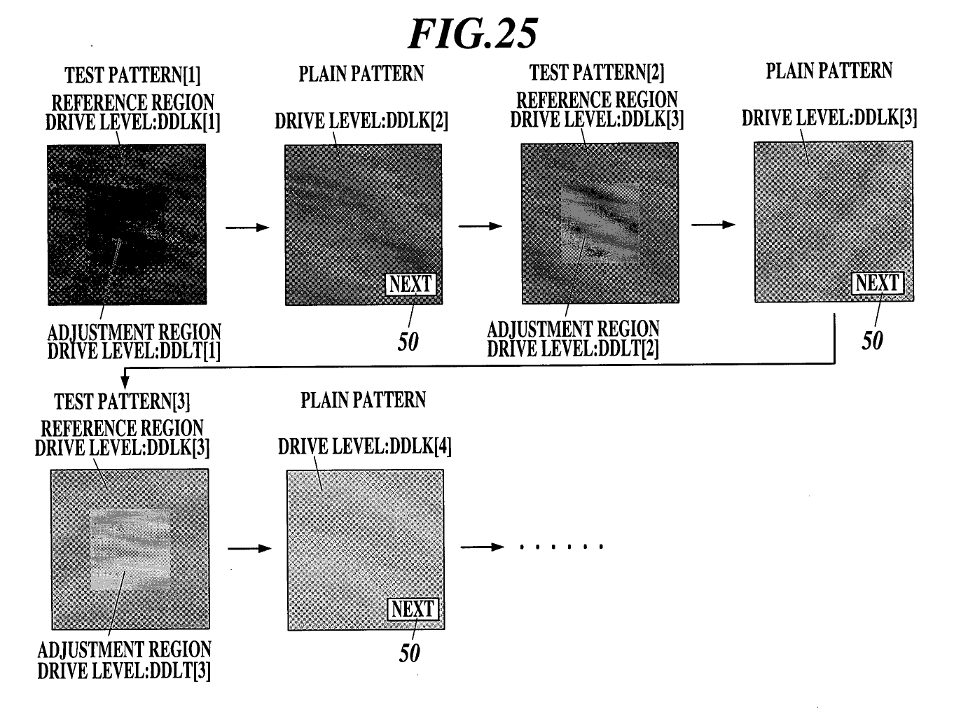

With reference to FIG. 25, the display order of the test patterns [n] and the plain patterns are described. As shown in FIG. 25, when a test pattern [1] has been displayed and the adjustment operation to the test pattern [1] has ended, a plain pattern is displayed at the drive level same as the drive level DDLK [2] of the reference region of the test pattern [2]. A “next” button 50 is displayed on the display screen of the display unit 13 on which the plain pattern is displayed. After the operator has confirmed that the afterimage of the boundary between the reference region and the adjustment region of the just preceding test pattern [1] has disappeared, the operator pushes down the “next” button 50 by an operation using the operation unit 12. The push-down signal of the “next” button 50 is outputted to the control unit 11, and the push-down signal is detected by the control unit 11. Then, a test pattern [2] is displayed. When the adjustment operation of the test pattern [2] has ended, a plain pattern is displayed at a drive level same as the drive level DDLK [3] of the reference region of a test pattern [3]. After the operator has confirmed that the afterimage of the just preceding test pattern [2] has disappeared, the operator pushes down the “next” button 50 by an operation using the operation unit 12. The push-down signal of the “next” button 50 is outputted to the control unit 11, and the push-down signal is detected by the control unit 11. Then, the test pattern [3] is displayed. After that, similarly the test patterns [n] and the plain patterns are displayed.

Returning to FIG. 24, when all of the test patterns [n] have been displayed and the adjustment operations have ended (Step S108; Y), the processing moves to the process at Step S112. In FIG. 24, because the processes at Steps S112-S115 are the same as the processes at Steps S72-S75 of the calibration processing 4 shown in FIG. 20, their descriptions are omitted.

This is the end of the calibration processing 6.

As described above, according to the seventh embodiment, because a plain pattern is displayed until an instruction from an operator is detected, it is possible to prevent the fall of the accuracy of the visibility of the operator owing to an afterimage. Consequently, calibration can be performed more accurately.

Incidentally, although the drive levels of the plain patterns are made to be the same drive levels as the drive levels DDLK [n] of the reference regions of the test patterns [n] displayed after the plain patterns in the seventh embodiment, the drive levels of the plain patterns may be a constant value similarly in the fifth embodiment.

Moreover, although the plain patterns are displayed in all transition processes from the display of one test pattern to the display of another test pattern at the time of displaying each test pattern [n] in the fifth to the seventh embodiments, a part of the displays of the plain patterns may be omitted. For example, plain patterns may be made to be displayed only at the parts corresponding to important luminance levels in the calibration processing, or plain patterns may be made to be displayed at a rate of once to several times of the transition processes switching the test patterns. By omitting a part of the displays of the plain patterns, the time necessary for calibration can be shortened.

The descriptions in each of the embodiments described above concern the examples of the preferable calibration method according to the present invention, and the present invention is not limited to the descriptions. Also the detailed configurations and the detailed operations of the respective units constituting the medical image display apparatuses can be suitably altered within a scope without departing from the sprit of the present invention.

Moreover, the drive level DDLK [N] of the reference region and the drive level DDLT [N] of the adjustment region of the test pattern [N] having the highest luminance among the test patterns [n] are made to be set to the values expressed by the formulae 3 and 4 in each embodiment described above. However, in the case where the drive level DDLT [N] of the adjustment region is gradually lowered from the maximum drive level DDLₘₐₓ to be adjusted to the drive level at which the luminance level difference between the luminance levels of the adjustment region and the reference region becomes the minimum luminance level difference capable of being visually recognized by visual observation, there is the possibility that the data in the neighborhood of the maximum drive level DDLₘₐₓ cannot be obtained. Accordingly, the drive level difference corresponding to the minimum luminance level difference capable of visually recognized may be obtained by changing the drive level DDLK [N] of the reference region to adjust the luminance level of the reference region to approximate the luminance level of the adjustment region only for the test pattern [N] having the highest luminance.

Moreover, the drive level difference corresponding to the minimum luminance level difference capable of visually recognized may be obtained conversely by setting the drive level DDLK [N] of the reference region to the maximum drive level DDLₘₐₓ, by setting the drive level DDLT [N] of the adjustment region to a drive level lower than the maximum drive level DDLₘₐₓ by a predetermined level, and by adjusting the luminance level of the adjustment region to approximate the luminance level of the reference region from the lower luminance side.

All the disclosed contents of Japanese Patent Application No. 2004-228106 filed on Aug. 4, 2004, and Japanese Patent Application No. 2004-230927 filed on Aug. 6, 2004 are incorporated in the present application.

What is claimed is:

1. A calibration method, comprising:
displaying an image for calibration at a position of a region of interest of a medical image to be a display object of a display unit of a medical image display apparatus;
adjusting a luminance level of the displayed image for calibration by observing by visual observation; and
correcting a display gradation characteristic of the medical image display apparatus based on an adjustment result.

2. The calibration method of claim 1, further comprising:
saving a position of a region of interest of a medical image displayed on the display unit in a past at every photographing portion and/or in every photographing direction, wherein
in displaying the image for calibration on the display unit, a position of a region of interest of a medical image having a photographing portion and/or a photographing direction same as that of the medical image to be the display object is obtained among the saved position of the region of interest, and the position of the region of interest of the medical image to be the display object is determined based on the obtained position of the region of interest to display the image for calibration at the determined position of the region of interest.

3. The calibration method of claim 1, wherein the position of the region of interest of the displayed medical image is appointed on a screen on which the medical image to be the display object is displayed by the display unit, and the image for calibration is displayed at the appointed position of the region of interest.

4. A calibration method, comprising:
displaying an image for calibration at each of a plurality of positions on a display screen of a display unit of a medical image display apparatus;
adjusting a luminance level of the displayed image for calibration by observing by visual observation;
obtaining correction data for correcting a display gradation characteristic of the medical image display apparatus based on an adjustment result; and
correcting the display gradation characteristic of the medical image display apparatus based on the correction data obtained in a neighborhood of a position of a region of interest of a medical image to be a display object when the medical image to be the display object is displayed on the display unit.

5. A calibration method, comprising:
making a display unit of a medical image display apparatus display one of a plurality of test patterns, each including a reference region and an adjustment region, on a screen in a way of being switched one by one;
making the display unit display a plain pattern having a single luminance level in a transition process from a display of a test pattern to a display of another test pattern;
adjusting a luminance level of the adjustment region of the displayed test pattern by observing by visual observation; and
correcting a display gradation characteristic of the medical image display apparatus based on an adjustment result.

6. The calibration method of claim 5, wherein
the single luminance level of the plain pattern is a luminance level same as that of a reference region of a test pattern displayed after the plain pattern.

7. The calibration method of claim 5, wherein
a display of the plain pattern is performed for a predetermined constant time or until detecting an instruction from an operator.

8. The calibration method of claim 5, wherein
a part of the displaying of the plain pattern is omitted.
